(19) United States
(12) Patent Application Publication
(10) Pub. No.: US 2008/0191455 A1
(43) Pub. Date: Aug. 14, 2008

(54) Safety Steering Column for a Motor Vehicle

(76) Inventors: Travis Bechtel, Goodrich, MI (US); Jens Bohlen, Eyendorf (DE); Christian Born, Hamburg (DE); Markus Brown, Armada, MI (US); Scott D. Duncan, Flint, MI (US); Fred Eggers, Buxtehude (DE); Axel Hebenstreit, Stuttgart (DE); Karl-Heinz Knoll, Weinstadt (DE); Peter Von Ey, Hamburg (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/587,181

(22) PCT Filed: Apr. 22, 2005
(86) PCT No.: PCT/EP2005/004324

§ 371 Date: Oct. 30, 2007

(30) Foreign Application Priority Data
Apr. 23, 2004 (DE) 10 2004 020 048.3

(51) Int. Cl. B62D 1/18

(52) U.S. Cl. 280/775

(57) ABSTRACT

A safety steering column (1) is provided for a motor vehicle, which has a telescopic steering spindle (2) with an upper spindle part (3) which is near to the steering wheel and a lower spindle part (4) which is remote from the steering wheel, and is rotatably mounted in a jacket tube (5). The jacket tube (5) is of telescopic design and has an upper tube part (6) which is near to the steering wheel and a lower tube part (7) which is remote from the steering wheel, the lower tube part (7) being mounted so as to be pivotable about a first axis (10) on a bracket (9) which can be arranged fixed to the vehicle. In addition, an adjustment device which serves to vertically adjust the safety steering column (1) and has an actuating element (12) which is mounted so as to be pivotable about a second axis (14) is provided. The safety steering column (1) is distinguished by the fact that the actuating element (12) is coupled to the jacket tube (5) by means of a force transmitting element (33) which can be adjusted in a translatory fashion in the axial direction relative to the jacket tube (5).

### BACKGROUND AND SUMMARY OF THE INVENTION

This application claims the priority of German patent document 10 2004 020 048.3, filed Apr. 23, 2004 (PCT International Application No. PCT/EP2005/004324, filed Apr. 22, 2005), the disclosure of which is expressly incorporated by reference herein.

The present invention relates to a safety steering column for a motor vehicle.

Safety steering columns, which are common in contemporary motor vehicle engineering, protect a driver of the motor vehicle in the event of an accident by moving out of a hazardous area of the vehicle in an active or passive fashion. In an active safety steering column, this movement is carried out automatically so that the driver normally does not impact against a steering handle which is arranged at an upper end of the steering column. A passive safety column can be moved out of the hazardous area when a predefined force is exceeded; for example an upper steering column part may be mounted so as to be axially displaceable with respect to a lower steering column part.

German patent document DE 101 30 908 A1 discloses a vehicle safety steering column which has a telescopic steering spindle composed of upper and lower spindle parts. It is rotatably mounted in a jacket tube by means of an upper bearing, which supports the upper spindle part on the jacket tube, and a lower bearing, which supports the lower spindle part on the jacket tube. Like the steering spindle, the jacket tube is also formed in a telescopic fashion and has an upper tube part which is near to the steering wheel and a lower tube part which is remote from the steering wheel. Both the spindle parts and the tube parts of the jacket tube are plugged one into the other and can be displaced relative to one another in response to a predetermined axial triggering force. The lower bearing is fixed, while the upper bearing is loose. The two spindle parts or the two tube parts are basically not displaced until the axial triggering force is exceeded, such as, for example, in the event of a crash. In order to adjust the steering column axially, and thus adapt it to individual requirements for a driver, it can be adjusted in its entirety (that is, with the upper and lower spindle or jacket tubes) along a guide.

German patent document DE 102 51 764 A1 discloses a safety steering column of this type, which can be electrically adjusted in the longitudinal and vertical directions. It has a telescopic steering spindle with an upper spindle part near the steering wheel and a lower spindle part remote from the steering wheel. The steering spindle is rotatably mounted in a jacket tube which has an upper tube part near to the steering wheel and a lower tube part remote from the steering wheel. The lower tube part is pivotable about a first axis on a bracket which can be fixed to the vehicle. In addition, an adjustment device, which serves to vertically adjust the jacket tube, has an actuating element pivotably mounted about a second axis on the bracket. The actuating element is coupled in an articulated fashion to a deflector bar mounted on the upper tube part, so as to be pivotable about an axis.

The operation of the adjustment device is similar to that of a toggle lever and is intended to ensure play-free vertical adjustment of the safety steering column, for reasons of comfort among others. The freedom from play of this lever arrangement is important in safety steering columns which can be adjusted by motor, particularly by means of spindle drives, because no separate clamping means are provided for securing the safety steering column in a desired position, such as are used in manually adjustable steering safety columns.

One object of the invention is to provide a safety steering column of the type mentioned above, which has a simple and cost-effective design, and in which the adjustment device is substantially free from play.

This and other objects and advantages are achieved by the safety steering column according to the invention, which comprises a telescopic steering spindle that has an upper spindle part near to the steering wheel and a lower spindle part remote from the steering wheel, and is rotatably mounted in a jacket tube. The jacket tube is also of telescopic design, and has an upper tube part near to the steering wheel and a lower tube part remote from the steering wheel. The lower tube part is pivotably mounted about a first axis, on a bracket which can be arranged fixed to the vehicle.

According to a first embodiment of the invention, the lower tube part can be guided in an axially adjustable fashion in the lower tube part, while in a second embodiment the upper tube part can be guided in an axially adjustable fashion in the lower tube part. The safety steering column also comprises an adjustment device which serves to vertically adjust the jacket tube and has an actuating element which is mounted so as to be pivotable about a second axis on the bracket.

The safety steering column is distinguished by the fact that the actuating element is coupled to the jacket tube by a force transmitting element which can be adjusted in a translatory fashion relative to the jacket tube. Due to the configuration according to the invention, the adjustment device has very little, but still sufficient play to permit the relative movement, necessary as a result of the different movement paths of the jacket tube and the force transmitting element, between these assemblies/parts in the event of a vertical adjustment of the safety steering column.

In a particularly advantageous embodiment of the invention, the force transmitting element can be guided in a guide which is provided on the outside of the jacket tube. Depending on the embodiment of the safety steering column, the guide may be provided either on the upper tube part or on the lower tube part. In this context, the force transmitting element can, for example, be embodied in a manner similar to a sliding block guided in a slot-shaped recess. The embodiment with the force transmitting element which is guided in a guide arranged on the outside of the jacket tube requires only a small installation space. Furthermore, it is possible to mount or guide the force transmitting element and the actuating element virtually without play. As a result, the rigidity of the steering column is enhanced while at the same time susceptibility to vibrations is diminished.

An embodiment of the safety steering column according to the invention in which a first actuating drive is provided for pivoting the actuating element about the first axis, and/or a second actuating drive is provided for longitudinally adjusting the safety steering column, is particularly preferred. Of course, the design of the safety steering column according to the invention may also be used in manually adjustable steering columns in which longitudinal and vertical adjustment are carried out manually by the driver after a clamping device has been released by applying a tensile or compressive force to the steering column or pushing it downward or upward. This permits extensive use of identical parts in the steering columns which can be adjusted by motor/electrically and mechanically in their longitudinal and vertical directions, so that a uniform crash principle can be implemented.

In a further preferred embodiment of the invention, the force transmitting element is formed by an outer tube part in which the upper tube part is guided in an axially adjustable fashion. The upper tube part serves as a guide for the outer tube part so that a particularly simple design of the safety steering column can be implemented. In this second exemplary embodiment of the safety steering column it is also possible for the upper tube part to be guided in an axially adjustable fashion in the lower tube part or alternatively for the lower tube part to be guided in an axially adjustable fashion in the upper tube part.

In the event of a crash, the telescopic steering column according to the invention provides a sufficient deformation path, thereby enhancing the safety of the vehicle. At the same time, the three jacket tube parts which are plugged one into the other permit comfort adjustment while requiring little installation space. Such adjustment allows the a position of the steering handle to be easily adapted to physical requirements of the respective driver. Furthermore, the design, with a total of three jacket tube parts and their play-free mounting one inside the other, increases the rigidity of the steering column, which permits the driving comfort to be increased, for example due to a reduced susceptibility to vibrations.

According to another preferred embodiment of the safety steering column according to the invention, the outer tube part is mounted on the bracket by means of a carriage. The actuating element, which is mounted on the carriage rotatably about a second axis on the outer tube part, so as to be rotatable about a third axis, is arranged between the outer tube part and the carriage. The carriage in turn is arranged in a fixed position on the bracket until misuse forces are overcome, and can be adjusted along its carriage guide when the misuse forces (that is, for example in the event of a vehicle crash) are exceeded. As a result the parts of the safety steering column slide telescopically one inside the other and the steering handle is pulled out of the hazard area of the driver. The actuating element, which is part of the vertical adjustment of the safety steering column, ensures precise positioning and positional fixing of the safety steering column in the desired adjustment position by virtue of its rigid design.

According to an advantageous embodiment of the invention, the actuating element engages around the outer tube part in a U shape. Each of the two arms of the U-shaped actuating element has an L-shaped bent end region, each of which ends is penetrated by the second and third axes. The L-shaped end regions protrude essentially in the orthogonal direction with respect to the U plane, which further increases the rigidity of the actuating element. The actuating element can be made, for example, from plastic or metal, and can thus be manufactured cost-effectively, with precise dimensions.

A first actuating drive is expediently attached to the carriage, and adjusts (by means of a spindle) an actuating arm which is rotationally fixed on the actuating element and thus pivots the safety steering column with respect to the first axis. Spindle drives are proven and precise devices for making adjustments so that the first actuating drive permits precise adaptation of the height of the steering handle by rotating/pivoting the safety steering column about the first axis. Furthermore, such a spindle drive is simple and cost effective to manufacture and requires little maintenance during operation. Depending on the height of the thread on the spindle, the height of the safety steering column or the steering handle can also be adjusted precisely in very small steps.

According to a further advantageous embodiment of the safety steering column, a second actuating drive which adjusts the upper tube part axially with respect to the outer tube part is attached to the outer tube part. The second actuating drive can also be operatively connected to the upper tube part by means of a spindle drive so that longitudinal adjustment is also easily possible. It is also possible for the first and second actuating drives to have an identical or comparable design which allows the variety of parts to be reduced and thus the production costs to be lowered.

According to one particularly preferred embodiment of the invention the first and/or second actuating drives have an electric motor. Electric motors are conceivable in virtually any desired embodiment and can be adapted precisely to respective requirements. Furthermore, electric motors permit low-maintenance operation, are cost-effective to manufacture and have a long service life due to high production quality nowadays.

In a further advantageous embodiment of the invention, a pressure element which presses the lower tube part radially against the upper tube part and thus presses the lower and upper tube parts radially against the outer tube part, is provided on the outer tube part. The pressure element is embodied, for example, as a spring or as a screw element, and ensures play-free bearing of the individual tube parts one in the other. At the same time, it makes the safety steering column rigid, thereby improving overall driving comfort.

To summarize, it is to be noted that all the representative embodiments of the safety steering column according to the invention involve the general idea of permitting both a simplified telescopic capability and a high degree of axial deformation in the event of a crash, in a safety steering column for a motor vehicle having a telescopic steering spindle which is mounted in a telescopic jacket tube.

Other objects, advantages and novel features of the present invention will become apparent from the following detailed description of the invention when considered in conjunction with the accompanying drawings.

### BRIEF DESCRIPTION OF THE DRAWINGS

In the drawings, identical reference symbols relate to identical or functionally identical or similar components.

FIG. 1 is a perspective view of a first exemplary embodiment of the safety steering column according to the invention;

FIG. 2 is a longitudinal section through the safety steering column according to the invention as in FIG. 1;

FIG. 3 is a side view with the steering spindle pivoted downward;

FIG. 4 corresponds to FIG. 3, but with the steering spindle pivoted upward;

FIG. 5 corresponds to FIG. 4, but with the steering spindle arranged parallel to the bracket, and with the upper tube part extended axially;

FIG. 6 corresponds to FIG. 5, but in a crash position; and

FIG. 7 is a perspective view of a second embodiment of the invention in a perspective illustration.

### DETAILED DESCRIPTION OF THE INVENTION

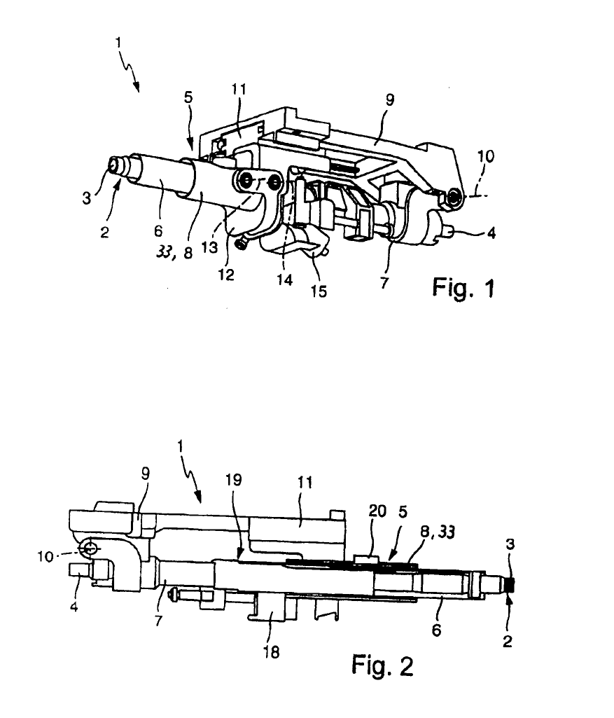

According to FIG. 1, a safety steering column 1 has a telescopic steering spindle 2 which is composed of an upper spindle part 3 near to the steering wheel and a lower spindle part 4 remote from the steering wheel. The spindle is rotatably mounted in a jacket tube 5 with a total of three parts. The jacket tube 5 is also of telescopic design and has an upper tube part 6 near to the steering wheel, a lower tube part 7 remote from the steering wheel and an outer tube part 8. The outer tube part 8 forms a force transmitting element 33 during the vertical adjustment of the safety steering column 1, on which further details will be given later.

The safety steering column 1 is usually installed in a motor vehicle and is mounted by means of a guide on a bracket 9 which is fixed to the vehicle. In order to vertically adjust the safety steering column 1 and a steering handle (not illustrated) arranged at the end of the upper spindle part 3, the lower tube part 7 is mounted pivotably about a first axis 10 on the bracket 9. At the same time, the lower tube part 7 is guided in an axially adjustable fashion in the upper tube part 6 (cf. FIG. 2), which is guided and mounted in an axially adjustable fashion in the outer tube part 8 that is in turn mounted in an axially adjustable fashion on the bracket 9.

The outer tube part 8 is mounted on the bracket 9 (which is fixed to the vehicle), by means of a carriage 11 which, in a comfort position, is arranged in a fixed position on the bracket 9. When misuse forces are exceeded (for example in the event of a crash), it is moved into a crash position in which it can be adjusted parallel to the axis of the safety steering column 1 (cf. FIG. 6) along a carriage guide (not shown in more detail).

An actuating element 12 is arranged on the outer tube part 8 and the carriage 11. It is mounted on the carriage 11 rotatably about a second axis 14, and on the outer tube part 8 rotatably about a third axis 13. The first axis 10, the second axis 14 and the third axis 13 all run parallel to one another here. The actuating element 12 is part of an adjustment device for vertically adjusting the jacket tube 5, on which further details will be given below.

The actuating element 12 is U shaped and engages around the outer tube part 8 with two arms of the U shape. According to FIG. 1, the two arms have an end region which is bent into an L shape and is penetrated by the second axis 14 and the third axis 13.

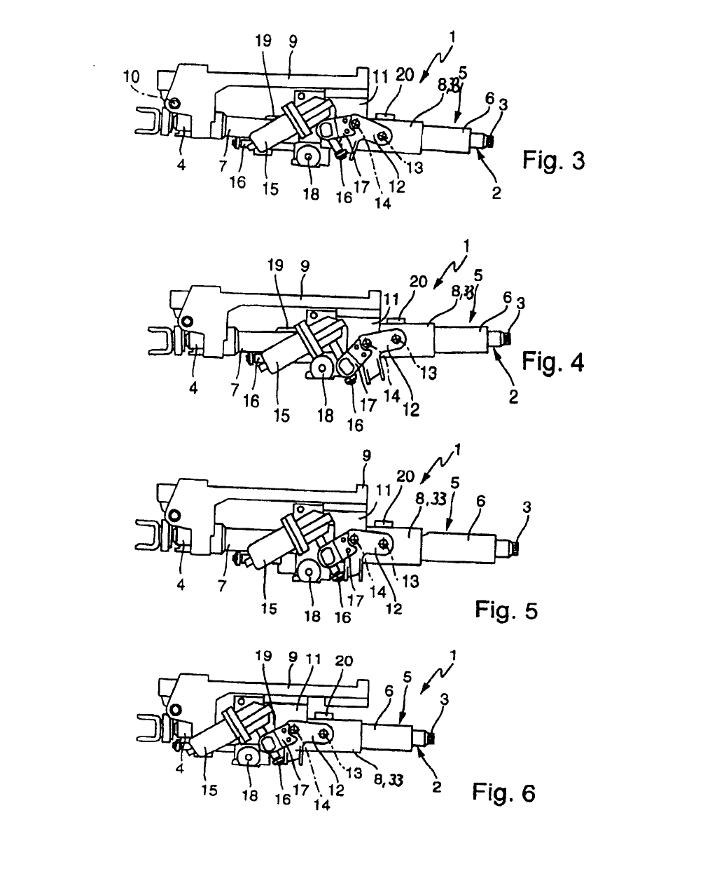

According to FIGS. 3 to 6, a first actuating drive 15 is attached to the carriage 11 and adjusts, by means of a spindle 16, an actuating arm 17 that is rotationally fixed on the actuating element 12, and thus pivots the safety steering column 1 with respect to the first axis 10. An end of the actuating arm 17 which faces away from the actuating element 12 has a drive connection here to the spindle 16 such that rotation of the spindle 16 brings about axial adjustment of the actuating arm 17 along the spindle axis.

The transmission of force from the first actuating drive 15 to the jacket tube 5 for the purpose of vertically adjusting the safety steering column 1 (that is, for pivoting the jacket tube 5 about the first axis 10) is carried out by pivoting the actuating element 12 about the second axis 14. Such pivoting causes the force transmitting element 33, which is formed by the outer tube part 8 and in which the upper tube part 6 is guided (preferably, with only a small degree of play) to be displaced. In the process, the force transmitting element 33 applies an actuating force to the upper tube part 6, causing the jacket tube 5 to pivot about the axis 10. In the process, the tubular force transmitting element 33 permits a relative movement of the upper tube part 6 with respect to the force transmitting element 33 in the direction of the longitudinal center axis of the jacket tube. Such movement is necessary, because the upper and lower tube parts 7 and 6 pivot about the first axis 10, while the outer tube part 8 pivots the force transmitting element 33 about the second axis 14.

Due to the relative movement of the upper tube part 6 with respect to the force transmitting element 33, the point of action of the force transmitting element 33 on the jacket tube also migrates back and forth in the axial direction with respect to a reference point on the jacket tube. In context with the present invention, the term “point of action of force” of course also means a bearing face/a contact region between the force transmitting element and the jacket tube.

The radial play between the outer tube part 8, the force transmitting element 33 and the upper tube part 6 guided therein is preferably very small, providing a steering column with a high degree of rigidity. The safety steering column 1 has, inter alia, a simple design due to the simple lever arrangement, composed of the U-shaped actuating element 12 in this exemplary embodiment.

FIG. 3 shows a first end position of the actuating arm 17 on the spindle 16 in which the safety steering column 1 has a large angle with respect to the bracket 9. In contrast, FIG. 4 shows a second end position of the actuating arm 17 on the spindle 16 in which the steering spindle 2 assumes a significantly smaller angle with respect to the bracket 9 compared to FIG. 3. FIG. 5 shows an intermediate position between the first end position assumed in FIG. 3 and the second end position of the safety steering column 1 assumed in FIG. 4. Vertical adjustment of the steering handle (not shown) can thus be achieved by means of the first actuating drive 15, which has, for example, an electric motor.

Furthermore, a second actuating drive 18 is attached to the outer tube part 8, and axially adjusts the upper tube part 6 with respect to the outer tube part 8. A first possible end position of a longitudinal adjustment of the upper tube part 6 is shown in FIG. 4, while FIG. 5 illustrates a second end position which is opposite the first possible end position. In FIG. 5, the upper tube part 6 is adjusted so that the safety steering column 1 is lengthened compared to the state illustrated in FIG. 4.

An adjustment mechanism can be provided with respect to the first actuating drive 15 in an analogous fashion, for example by means of a spindle drive. The second spindle drive 18 thus permits longitudinal adjustment of the safety steering column 1 and thus adaptation of the distance of a steering wheel from a driver as well as adaptation to its physiological requirements. The second actuating drive 18 can be connected by a clip 19 (cf. FIG. 2) to a lower end of the upper tube part 6 and to engage around it tightly.

FIGS. 1 to 5 each illustrate a comfort position of the safety steering column 1 which characterizes a normal state and permits easy adjustment of the safety steering column 1 with respect to its length and/or height.

In order to reduce the risk of injury to the driver in the event of a crash due to an impact of said driver against the steering handle, when a crash occurs or when misuse forces are exceeded, the safety steering column 1 can be moved into a crash position which is shortened significantly in the axial direction compared to the comfort position, and thus moves the steering handle out from the immediate hazardous region in the direction of a dashboard.

For this purpose, the carriage 11 is configured such that, in the event of a crash it is adjusted along its carriage guide with respect to the bracket 9, shortening steering column 1 by telescoping of the individual tube parts 6, 7, 8. Such a shortened safety steering column 1 is shown in FIG. 6, from which it is apparent that the first actuating drive 15, the second actuating drive 18, the outer jacket tube 8 and the upper tube part 6 are pushed in the direction of the lower spindle part 3. In the process, a crash path is provided; that is, the difference between the longitudinal extent of the safety steering column 1 between the comfort position and the crash position is, for example, approximately 100 mm. This reduces or eliminates the risk of injury to the driver as a result of an impact against the steering handle.

In order to ensure, in the comfort position (FIG. 1 to FIG. 5), mounting of the safety steering column 1 with as few vibrations as possible and as rigidly as possible, a pressure element 20 provided on the outer tube part 8 presses the lower tube part 7 radially against the upper tube part 6 and thus the lower and upper tube parts 7 and 6 radially against the outer tube part 8. The pressure element 20 can be embodied as a spring package or as a screwed pressure element, or it can have a comparable arrangement which permits the lower and upper tube parts 7 and 6 to be pressed radially against the outer tube part 7 and thus be guided one in the other without play.

To summarize, in the safety steering column 1 described with reference to FIGS. 1 to 6, the safety steering column 1 has both a telescopic steering handle 2 and a telescopic jacket tube 5 which is composed of a total of three parts. The jacket tube 5 is composed here of a lower tube part 7, which is mounted so as to be pivotable about the first axis 10 on the bracket 9 which is fixed to the vehicle, and is guided in an axially adjustable fashion in the upper tube part 6. In contrast, the upper tube part 6 is guided in an axially adjustable fashion in the outer tube part 8 which is positioned in an axially adjustable fashion on the bracket 9. By reason of this configuration, the safety steering column 1 according to the invention permits easy vertical and/or longitudinal adjustment in a comfort position and can be moved into a crash position in the event of a crash or when misuse forces are exceeded. In the crash position, the axial longitudinal extent of the safety steering column 1 is significantly shortened compared to the comfort position. The three jacket tube parts 6, 7 and 8 which can telescope inside one another are mounted one in the other without play by means of a pressure element 20, achieving a high degree of rigidity of the safety steering column 1 and increased driving comfort. As a result, both the comfort position and the displacement in the event of a crash are implemented with a significantly smaller installation space compared to conventional safety steering columns.

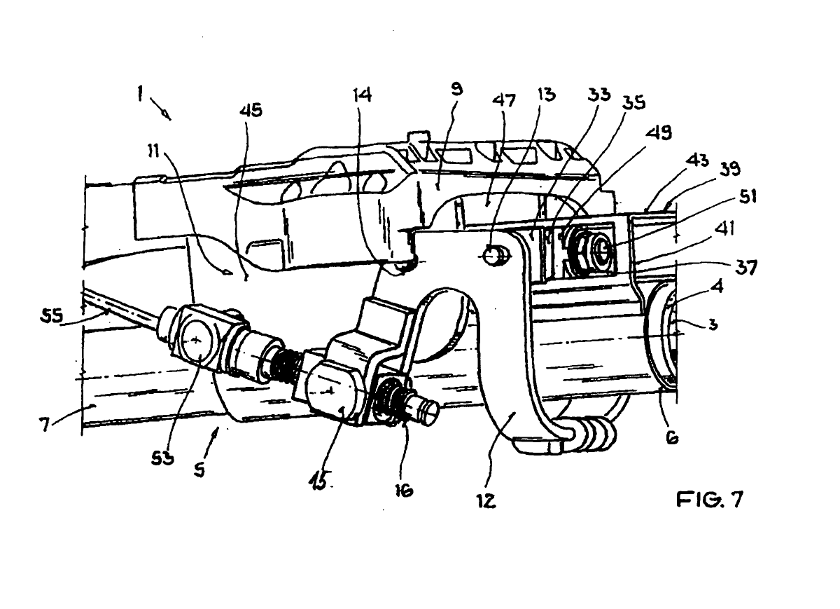

FIG. 7 is a perspective view of a detail of a second exemplary embodiment of the safety steering column 1. Identical parts are provided with identical reference symbols so that reference is made in this respect to the description of the preceding figures. Details will only be given below on important differences.

The force transmitting element 33 (by which the actuating element 12 mounted on the carriage 11 so as to be rotatable about the second axis 14 is coupled to the jacket tube 5) is formed by a guide element 35. The latter is similar to a sliding block, and is mounted so as to be rotatable about the third axis 13 on the U-shaped actuating element 12. It is guided with minimal play in a slit-shaped recess 37 in a guide 39. The recess 37 runs parallel to the longitudinal center axis of the safety steering column 1.

In this embodiment, the guide 39 is attached to the outside of the upper tube part 6. When the upper tube part 6 is displaced axially by the second actuating drive 18, the guide 39 can likewise be moved along in the axial direction of the steering column 1 for the purpose of longitudinal adjustment of the safety steering column. The guide 39 has a U-shaped profile, of which only one of the arms 41 and a wall 43 (which connects the arms to one another) can be seen in the illustration in FIG. 7. The recess 37 is in the arm 41. The second arm, which is not shown, preferably also has a recess 37 in which a further force transmitting element 33 is guided axially, as described above. However, basically one force transmitting element 33 is sufficient for the desired function of the adjustment device according to the invention. In the text which follows it is assumed that the adjustment device comprises two such force transmitting elements 33 here.

At least in the position of the safety steering column 1 illustrated in FIG. 7, the guide 39 engages in the free space between the limbs 45 and 47 of the carriage 11 which is at least essentially U-shaped here. For the purpose of reducing the vibrations and increasing the rigidity of the safety steering column 1, the carriage 11 can be used for precisely guiding the guide 39. For this purpose a sufficiently small amount of play is to be provided between the limbs of the guide 39 and the limbs 45, 47 of the carriage 11.

As is apparent from FIG. 7, a bearing block 49 for a spindle 51 of the second actuating drive 18, connected fixed in terms of position to the upper tube part 6 and/or the guide 39, is arranged in the free space between the force transmitting elements 33 which are each guided in one recess 37. The second actuating drive 18 can comprise, for example an electric motor which is arranged on the bracket and which drives the spindle 51 via a flexible drive shaft. The upper tube part 6 is displaced axially by rotating the spindle 51, changing the length of the safety steering column 1. Due to the slit-shaped recess 37, virtually no force is transmitted to the force transmitting element 33 here.

FIG. 7 also shows the spindle 16 of the first actuating drive 15, which serves to vertically adjust the safety steering column 1 and is pivotably coupled directly to the actuating element 12 by means of a bearing block 53. The spindle 16 is rotated by an electric motor (not illustrated) which applies torque to a flexible drive shaft 55 which is coupled to the spindle 16. Depending on the direction of rotation of the spindle 16, the actuating element 12 is pivoted about the second axis 14, fixed to the bracket, in the clockwise direction or the counterclockwise direction. Due to the coupling of the actuating element 12 by the at least one force transmitting element 33 to the guide 39 which is attached to the upper tube part 6, such pivoting causes the jacket tube 5 to pivot about the first axis 10 (which cannot be seen in FIG. 7). When the jacket tube pivots about the axis 10, a relative movement occurs between the force transmitting element 33 and the jacket tube 5 due to the various movement paths thereof, which is possible as a result of the slit-shaped recess 37. Due to the change in position of the force transmitting element 33 within the recess 37, the position of the point of action of the force of the force transmitting element also changes. That is, the position of the bearing contact face of the force transmitting element on the guide changes with respect to the jacket tube.

The safety steering column 1 which is described with respect to FIG. 7 and whose length and height can be adjusted by motor (in particular, an electric motor), has a vertical adjustment device with a particularly simple and space-saving design which is easy to manufacture and in which only a small amount of play between the small number of individual components of the lever/adjustment mechanism. It can also be implemented in a simple and advantageous fashion. For this purpose, in particular only a correspondingly small amount of play has to be provided between the force transmitting elements 33 and the respective recess 37.

Due to the small amount of play between the individual components of the longitudinal and vertical adjustment device there is no need for additional, manual clamping means for securing the safety steering column 1 in any desired position without play. The safety steering column 1 is secured exclusively by coupling the first and second actuating drives 15 and 18 in the way described above.

The exemplary embodiments of the safety steering column 1 described with reference to FIGS. 1 to 7 are equally suitable for vertical and longitudinal adjustment of the safety steering column 1 by motor or manually, so that the variety of parts is reduced. Both exemplary embodiments of the safety steering column 1 have in common the fact that vertical adjustment does not change the length of the safety steering column 1, or require a change in length. Conversely, a change in length of the safety steering column 1 does not lead to vertical adjustment thereof. When there is a change in length of the safety steering column 1, force is not applied (or is applied only to a negligible degree) to the force transmitting element 33, which in the exemplary embodiment according to FIGS. 1 to 6 is implemented by leading the jacket tube through the force transmitting element, and in the exemplary embodiment according to FIG. 7 by means of the slit-shaped recess 37 in which the force transmitting element 33 is guided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-16. (canceled)

17. A safety steering column for a motor vehicle, comprising:
a telescoping steering spindle which has an upper spindle part near to the steering wheel and a lower spindle part remote from the steering wheel, and is rotatably mounted in a jacket tube;
a telescoping jacket tube in which the telescoping steering spindle is mounted, said jacket tube having an upper tube part which is near to the steering wheel, and a lower tube part which is remote from the steering wheel and is pivotably mounted about a first axis, on a bracket that is adapted to be fixedly arranged on the vehicle; and
an adjustment device for vertically adjusting the safety steering column, said adjustment device having an actuating element mounted so as to be pivotable about a second axis on the bracket;
wherein, the actuating element is coupled to the jacket tube by a force transmitting element that can be adjusted in a translatory fashion in the axial direction, relative to the jacket tube.

18. The safety steering column as claimed in claim 17, wherein the force transmitting element is guided in a guide provided on the outside of the jacket tube.

19. The safety steering column as claimed in claim 17, wherein the force transmitting element is mounted rotatably about a third axis on the actuating element.

20. The safety steering column as claimed in claim 17, wherein the actuating element is mounted on the bracket by a carriage.

21. The safety steering column as claimed in claim 17, wherein one of the following is true:
a first actuating drive is provided for pivoting the actuating element about the first axis; and
a second actuating drive is provided for longitudinally adjusting the safety steering column.

22. The safety steering column as claimed in claim 17, wherein the force transmitting element is formed by an outer tube part in which the upper tube part is guided in an axially adjustable fashion.

23. The safety steering column as claimed in claim 22, wherein:
the outer tube part is mounted on the bracket by means of a carriage; and
the actuating element is arranged between the outer tube part and the carriage and is mounted on the carriage rotatably about a second axis, and on the outer tube part rotatably about a third axis.

24. The safety steering column as claimed in claim 17, wherein the first axis, the second axis and the third axis are parallel to one another.

25. The safety steering column as claimed in claim 17, wherein:
the actuating element is embodied in a U shape or has a U-shaped region; and
the jacket tube is arranged between sides of the U section.

26. The safety steering column as claimed in claim 25, wherein the two sides of the U-shaped actuating element have an end region which is bent into an L shape; and
the second axis and the third axis both penetrate the L-shaped end regions.

27. The safety steering column as claimed in claim 22, wherein a first actuating drive is attached to the carriage and adjusts, by means of a spindle, an actuating arm which is arranged rotationally fixed on the actuating element and as a result rotates the safety steering column with respect to the first axis.

28. The safety steering column as claimed in claim 22, wherein a second actuating drive which axially adjusts the upper tube part with respect to the outer tube part is attached to the outer tube part.

29. The safety steering column as claimed in claim 28, wherein the second actuating drive is connected to a lower end of the upper tube part by means of a clip and engages around said upper tube part.

30. The safety steering column as claimed in claim 21, wherein one of actuating drive and the second actuating drive have an electric motor.

31. The safety steering column as claimed in claim 17, wherein the carriage is configured to adjust itself along its carriage guide with respect to the bracket in such a way that the safety steering column is shortened as a result of the telescoping of the tube parts.

32. The safety steering column as claimed in claim 22, further comprising a pressure element on the outer tube wall which presses the lower tube part radially against the upper tube part, and thus presses the lower tube part and upper tube part radially against the outer tube part is provided on the outer tube part.
